(19) United States
(12) Patent Application Publication
(10) Pub. No.: US 2015/0253650 A1
(43) Pub. Date: Sep. 10, 2015

(54) Image Capture Device and Clamping Mechanism

(71) Applicants: Sintai Optical (Shenzhen) Co., Ltd., Shenzhen City (CN); Asia Optical International Ltd., Tortola (GB)

(72) Inventors: Chang-Yi Huang, Shenzhen City (CN); Kun-Lun Chen, Shenzhen City (CN); Jia-Hong He, Shenzhen City (CN)

(21) Appl. No.: 14/604,820

(22) Filed: Jan. 26, 2015

(30) Foreign Application Priority Data
Mar. 6, 2014 (CN) 201410082036.9

(51) Int. Cl. G03B 17/56; H04N 5/225; F16M 13/02

(52) U.S. Cl. CPC G03B 17/561; F16M 13/022; H04N 5/2251

(57) ABSTRACT

An image capture device and a clamping mechanism are provided. The clamping mechanism includes a main body, a holder, and a clamping member. The main body has two opposite surfaces, a first pivot portion and a second pivot portion, wherein the first pivot portion and the second pivot portion are disposed on the surfaces. The holder includes a fixing element for fixing an electronic device, wherein the holder is disposed on the first pivot portion and rotatable with respect to the main body on a plane. The clamping member is disposed on the second pivot portion and rotatable with respect to the main body on the plane.

### BACKGROUND OF THE INVENTION

1. Field of the Invention

The invention relates to an image capture device and a clamping mechanism.

2. Description of the Related Art

Handheld devices, especial small handheld devices, have become indispensible in people's daily life. Although the small handheld devices are easily to carry, they are too small to hold and operate easily. Falling of the small handheld devices due to accidental collisions can be avoided if the small handheld devices are fixed in advance.

### BRIEF SUMMARY OF THE INVENTION

The invention provides an image capture device and clamping mechanism. The clamping mechanism is configured to secure an electronic device (or a photo shooting module) and be stably fixed to an external device by clamping, so that the electronic device can be stably operated and the photo shooting module can stably capture images.

The clamping mechanism in accordance with an exemplary embodiment of the invention includes a main body, a holder, and a clamping member. The main body has two opposite surfaces, a first pivot portion and a second pivot portion, wherein the first pivot portion and the second pivot portion are disposed on the surfaces. The holder includes a fixing element for fixing an electronic device, wherein the holder is disposed on the first pivot portion and rotatable with respect to the main body on a plane. The clamping member is disposed on the second pivot portion and rotatable with respect to the main body on the plane.

In another exemplary embodiment, the first pivot portion is a hinge.

In yet another exemplary embodiment, the fixing element includes a rotational portion and a screw rod connected to the rotational portion.

In another exemplary embodiment, the second portion includes a shaft and a torsion spring disposed on the shaft.

In yet another exemplary embodiment, the main body and the clamping member are made of an elastic material.

The image capture device in accordance with an exemplary embodiment of the invention includes a clamping mechanism including a main body, a holder and a clamping member, wherein the main body comprises a first pivot portion and a second pivot portion, the holder comprises a fixing element, the holder is pivoted to the main body through the first pivot portion, and the clamping member is pivoted to the main body through the second pivot portion; and a photo shooting module secured to the holder through the fixing element.

In another exemplary embodiment, the fixing element includes a screw rod, and the photo shooting module includes a screw hole engaged with the screw rod.

In yet another exemplary embodiment, the second pivot portion includes a shaft and a torsion spring disposed on the shaft, and the shaft extends through a plurality of first through holes formed on the main body and a plurality of second through holes formed on the clamping member.

In another exemplary embodiment, the photo shooting module comprises a lens and an image sensor.

In yet another exemplary embodiment, the first pivot portion includes a hinge through which an angle between the holder and the main body is less than or equal to 95°.

In another exemplary embodiment, the main body further has an antiskid area.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of an embodiment of a clamping mechanism of the invention;

FIG. 2 is a side view of FIG. 1;

FIG. 3 is a schematic view from another view angle of FIG. 1;

FIG. 4 is a schematic view of an embodiment of a holder of a clamping mechanism of the invention;

FIG. 5 depicts the clamping mechanism of FIG. 4 clamping to an external device;

FIG. 6 is a schematic view of an embodiment of an image capture device of the invention; and

FIG. 7 is a schematic view of the image capture device of FIG. 6 clamping to an external device.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

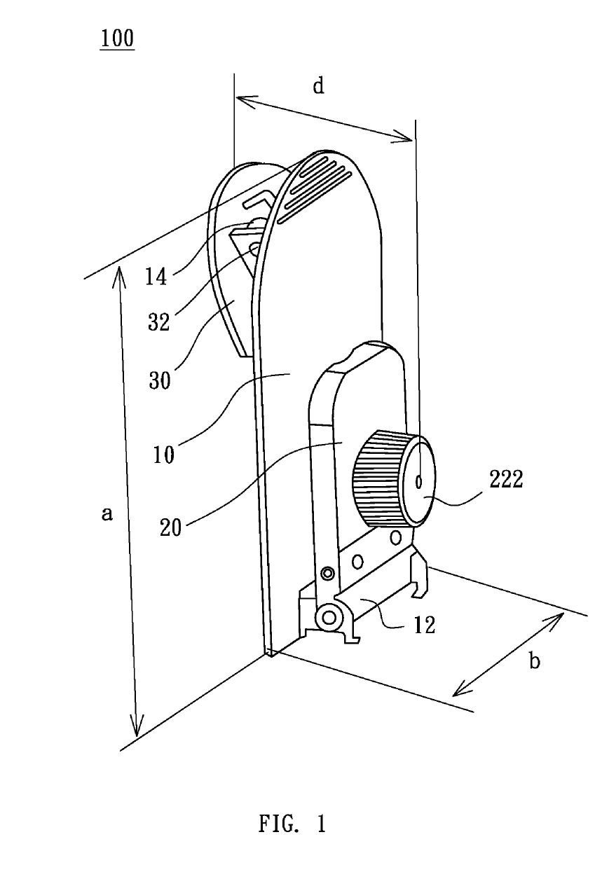

Referring to FIGS. 1, 2 and 3, the clamping mechanism 100 of the invention includes a main body 10, a holder 20 and a clamping member 30.

The main body 10 includes a fist pivot portion 12 and a second pivot portion 14. The first pivot portion 12 is disposed on a surface of the main body 10. The second pivot portion 14 is disposed in another surface opposite to the surface on which the first pivot portion 12 is disposed. The holder 20 includes a fixing element 22. The fixing element 22 is disposed on the holder 20. The holder 20 is rotatable with respect to the main body 10 on a plane.

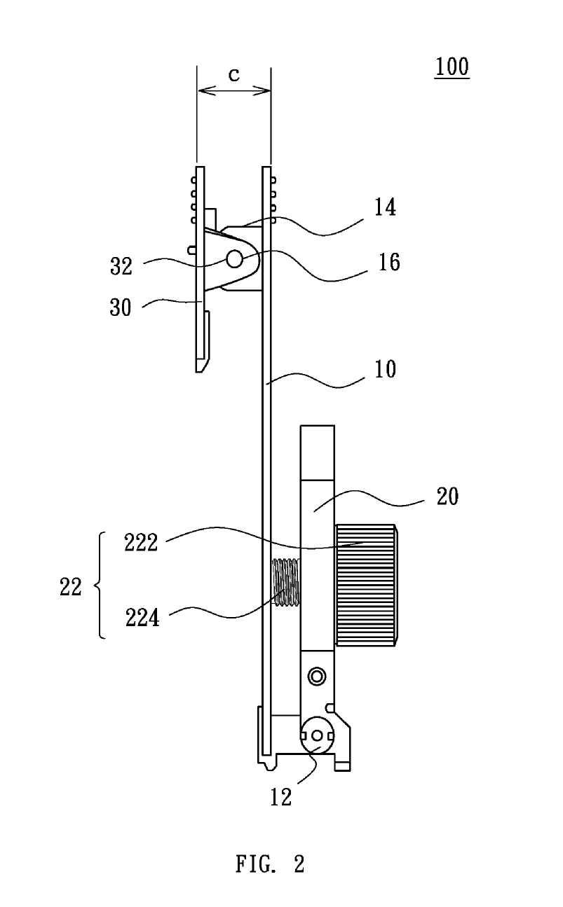

As shown in FIG. 2, the fixing element 22 includes a rotational portion 222 and a screw rod 224. The screw rod 224 is fixed to the rotational portion 222. When the rotational portion 222 rotates, the screw rod 224 is rotated by the rotational portion 222.

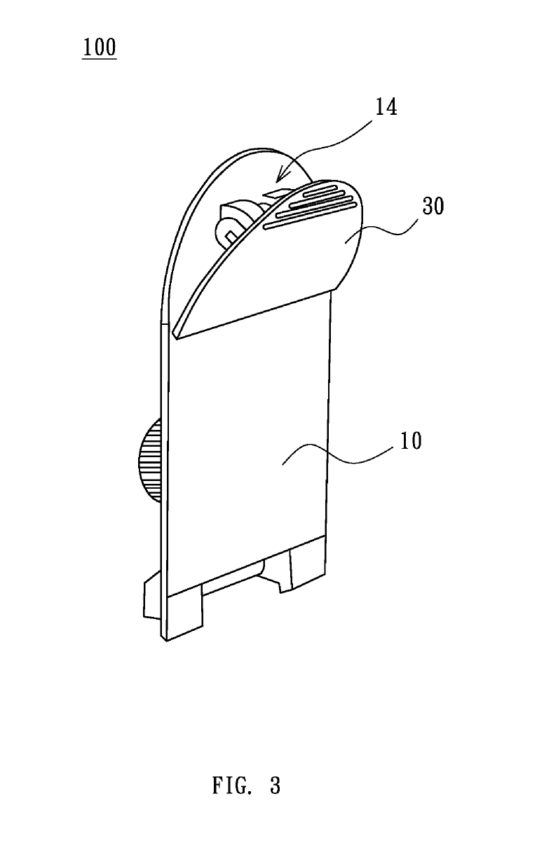

Referring to FIG. 1 and FIG. 3, the clamping member 30 is disposed on the second pivot portion 14, and the clamping member 30 is rotatable with respect to the main body 10 through the second pivot portion 14. The relative rotation between the clamping member 30 and the main body 10 and the relative rotation between the holder 20 and the main body 10 are on the same plane.

Referring to FIGS. 1 to 3, the main body 10 has a height ranging from 80 mm to 95 mm and a width b ranging from 50 mm to 65 mm. When the main body 10 is parallel to the clamping member 30, as shown in FIG. 2, the distance c between the main body 10 and the clamping member 30 ranges from 10 mm to 17 mm, and the maximal distance d between the holder 20 and the clamping member 30 ranges from 25 mm to 35 mm. However, the invention is not limited thereto.

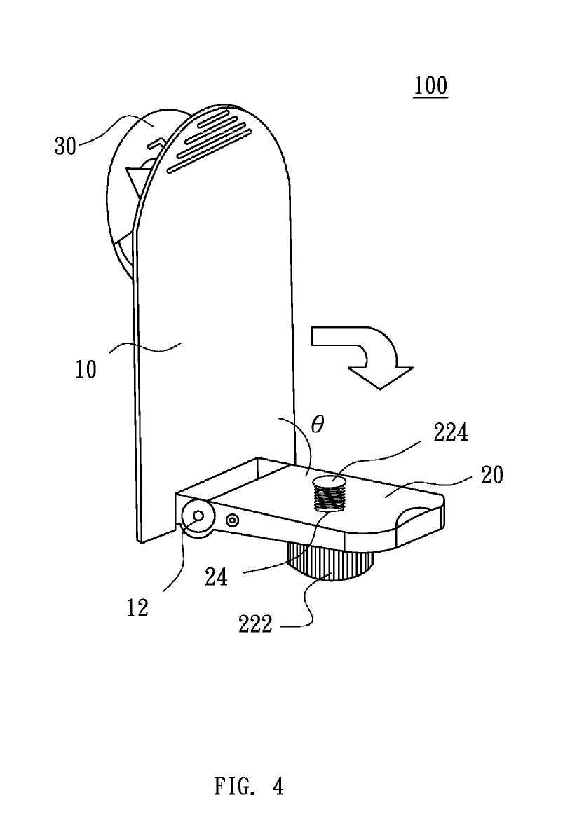

Referring to FIGS. 1 and 4, the first pivot portion 12 may be a hinge. One end of the hinge is fixed to the surface of the main body 10, and the other end of the hinge is fixed to the holder 20, whereby the relative rotation between the main body 10 and the holder 20 is possible through the hinge.

As shown in FIG. 1, the clamping mechanism 100 is closed, and the angle θ between the main body 10 and the holder 20 is 0. As shown in FIG. 4, the clamping mechanism 100 is opened, and the angle θ between the main body 10 and the holder 20 is 90°. In other words, the angle 0 between the main body 10 and the holder 20 ranges between 0±5° and 90±5°, but the invention is not limited thereto.

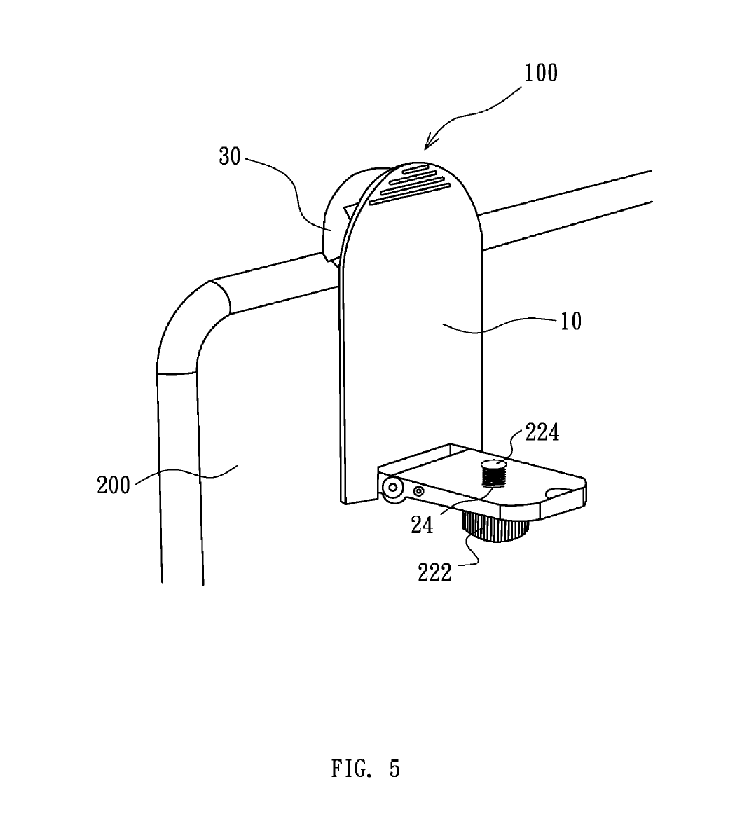

Referring to FIGS. 3 and 5, the second pivot portion 14 includes a shaft (not shown) and a torsion spring (not shown) disposed on the shaft. Two ends of torsion spring exert a torsion force on the main body 10 and the clamping member 30. When a force against the torsion force is exerted on the clamping member 30, the clamping member 30 is rotated relative to the main body 10 through the shaft to generate a gap therebetween. When an external device 200 is placed between the main body 10 and the clamping member 30, the force exerted on the clamping member 30 is removed, and the external device 200 is clamped by the clamping mechanism 100. The external device 200 can be a handheld device which includes a laptop, a tablet, a mobile phone or other communication devices, but it is not limited thereto.

Referring to FIGS. 2 and 5, the main body 10 includes at least two first through holes 16, and the clamping member 30 includes at least two second through holes 32. The shaft extends through the first through holes 16 and the second through holes 32, and the torsion spring is also disposed between the first through holes 16 and the second through holes 32 and disposed on the shaft. In addition, the main body 10 and the clamping member 30 can be made of elastic material such as rubber, plastic, silicon, particular in the areas contact the external device 200 to prevent the clamping mechanism 100 from scratching the external device 200. In addition, an antiskid is disposed on a surface of the main body 10. The antiskid area is formed by plurality of pads or rough surfaces.

The fixing element 22 can secures an electronic device. The electronic device includes a photo shooting module 300, a camera, a mobile phone or other communication devices, but it is not limited thereto.

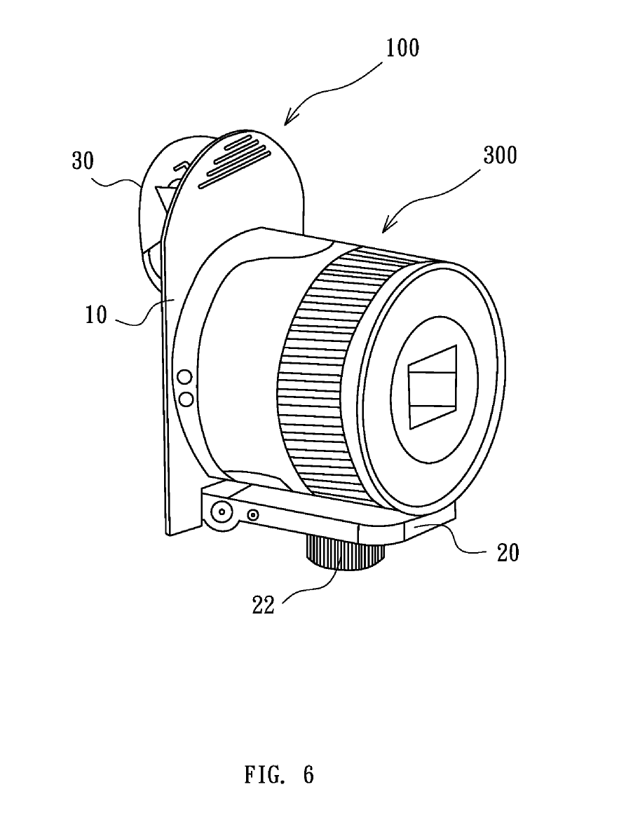

Referring to FIG. 6, an image capture device includes the clamping mechanism 100 and a photo shooting module 300. The clamping mechanism 100 in this embodiment is similar to the clamping mechanism 100 shown in FIGS. 1 to 5, and the same elements are presented by the same number.

Referring to FIGS. 2, 5 and 6, the photo shooting module 300 is fixed to the holder 20. The holder 20 includes a through hole 24. The fixing element 22 has a rotational portion 222 disposed on one side of the holder 20, and the screw rod 224 extends through the through hole 24 to the other side of the holder 20. The photo shooting module 300 includes a screw hole (not shown) to which a screw rod 224 corresponds. The screw rod 224 is rotated by the rotational portion 222 to engage the screw hole so that the photo shooting module 300 is secured to the clamping mechanism 100.

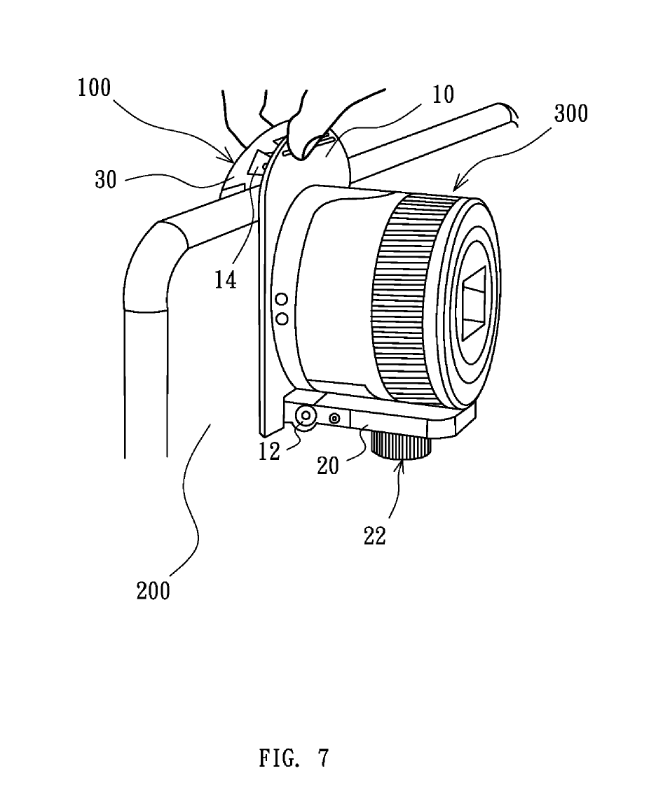

Referring to FIGS. 5-7, when the photo shooting module 300 is secured to the holder 20 through the fixing element 22, the photo shooting module 300 can be fixed to an external device 200 through the clamping member 30.

In this embodiment, the photo shooting module 300 further includes a lens and an image sensor.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A clamping mechanism, comprising:
a main body having two opposite surfaces, a first pivot portion and a second pivot portion, wherein the first pivot portion and the second pivot portion are disposed on the surfaces;
a holder comprising a fixing element configured to secure an electronic device, wherein the holder is disposed on the first pivot portion and rotatable with respect to the main body on a plane; and
a clamping member disposed on the second pivot portion and rotatable with respect to the main body on the plane.

2. The clamping mechanism as claimed in claim 1, wherein the first pivot portion is a hinge.

3. The clamping mechanism as claimed in claim 1, wherein the fixing element comprises a rotational portion and a screw rod connected to the rotational portion.

4. The clamping mechanism as claimed in claim 1, wherein the second portion comprises a shaft and a torsion spring disposed on the shaft.

5. The clamping mechanism as claimed in claim 1, wherein the main body and the clamping member are made of an elastic material.

6. An image capture device, comprising:
a clamping mechanism comprising a main body, a holder and a clamping member, wherein the main body comprises a first pivot portion and a second pivot portion, the holder comprises a fixing element, the holder is pivoted to the main body through the first pivot portion, and the clamping member is pivoted to the main body through the second pivot portion; and
a photo shooting module secured to the holder through the fixing element.

7. The image capture device as claimed in claim 6, wherein the fixing element comprises a screw rod, and the photo shooting module comprises a screw hole engaged with the screw rod.

8. The image capture device as claimed in claim 6, wherein the second pivot portion comprises a shaft and a torsion spring disposed on the shaft, and the shaft extends through a plurality of first through holes formed on the main body and a plurality of second through holes formed on the clamping member.

9. The image capture device as claimed in claim 6, wherein the photo shooting module comprises a lens and an image sensor.

10. The image capture device as claimed in claim 6, wherein the first pivot portion comprises a hinge through which an angle between the holder and the main body is less than or equal to 95°.

11. The image capture device as claimed in claim 6, wherein the main body further has an antiskid area.
